(19) United States
(12) Patent Application Publication
(10) Pub. No.: US 2026/0364983 A1
(43) Pub. Date: Nov. 19, 2026

(54) TOW HITCH LATCHING AND LOCKING ARRANGEMENT

(71) Applicant: Glic Ltd, Aberdeenshire (GB)

(72) Inventors: Gary WEBSTER, Aberdeenshire (GB); Richard CRONK, Coventry (GB)

(21) Appl. No.: 19/674,313

(22) Filed: May 12, 2026

(30) Foreign Application Priority Data
May 15, 2025 (GB) 2507528.4

(51) Int. Cl. B60D 1/28; B60D 1/06

(52) U.S. Cl. CPC B60D 1/28; B60D 1/065

(57) ABSTRACT

A tow cup 5 for a tow hitch assembly including a body 6 having upper 6a and lower 6b sides. A cavity 7 is formed in the body to receive a complementary tow ball. The body 6 has a passage 8 which extends from the cavity 7, and a shoe 9 is mounted in the passage 8 so as to be moveable between a retracted position so as to allow a tow ball 4 to engage into or disengage from the cavity 7, and an extended position so as to obstruct the cross section of the cavity 7 and prevent a tow ball 4 from engaging into or disengaging from the cavity 7. The tow cup 5 further includes drive means operable to move the shoe 9 between said engaged and disengaged positions and retain the shoe 9 in each said position.

### BACKGROUND OF THE INVENTION

### 1. Field of the Invention

The present invention relates to latching arrangements for retaining a tow ball in a tow cup of a tow hitch assembly and to locking systems for preventing unintentional release of the latching arrangements

### 2. The Prior Art

A tow hitch assembly well known in the art comprises a tow ball which is carried on the back of a vehicle which is to do the towing, and a tow cup provided on a vehicle which is to be towed. The tow cup has a generally cylindrical recess which is open at the bottom and has a hemispherical inner end at the top, the recess being sized and shaped so that the tow ball on the towing vehicle can engage in the recess of the tow cup through the open bottom to couple the two parts together. A latching jaw or shoe is mounted in the tow cup so as to be moveable between an engaged position in which it extends into the recess so as to partially obstruct the opening at the bottom and a disengaged position in which it is retracted from the recess. A spring is provided in the tow cup which engages the latching jaw so as to bias it in the engaged position, the latching jaw being retractable against the loading of the spring. Due to the obstruction in the opening at the bottom of the recess caused by the latching jaw, the tow ball can be neither engaged in nor removed from the tow cup with the latching jaw in its engaged position.

The latching jaw has inclined upper and lower surfaces so that when the tow cup is dropped onto or lifted off of the tow ball, the spherical outer surface of the tow ball develops a camming action with the latching jaw, causing it to retract against the loading of the spring. In order to prevent unintentional release of the tow ball from the tow cup, a locking system for the latch is included in the tow cup in the form of a member which engages behind the latching jaw when it is in the engaged position to prevent it from being retracted. In order to either engage a tow ball into the recess into or remove it from the recess in the tow cup, the plate has to be moved out of the way of the latching jaw, usually by lifting a lever on the top of the tow cup. To improve security, it is usual for a secondary lock or the like to be present to prevent removal of the tow ball from the tow cup. In one well known system a secondary lock takes the form of a latch which engages with the lever on the tow cup to prevent it from being lifted, the latch accordingly has to be moved by the operator before they can lift the lever.

This prior art system works effectively for manually operated tow hitches, particular since the operator is easily able to manually feel and check that the tow ball is properly and fully engaged in the tow cup. However, the applicant for the present case has been developing automated trailer fastening systems which can operate to attach and disengage a trailer from a vehicle without any manual intervention. Whilst it could be possible to utilise servos, sensors etc to automate the prior art system described above, not only would the system be complicated and cumbersome, it would also be prone to damage and failure, and, more importantly, could be unreliable with regard to proper operation of primary and secondary locks, which, in turn, could result in unintentional decoupling of a trailer from the towing vehicle.

### SUMMARY OF THE INVENTION

According to the present invention there is provided a tow cup for a tow hitch assembly comprising a body having opposing upper and lower sides, and a cavity formed therein which is open to the lower side of the body and is sized and shaped to receive, in use, a complementary tow ball of the tow hitch assembly, the body further including a passage formed which extends from the cavity, and a shoe mounted in the passage so as to be moveable between a retracted position in which the shoe is retracted from the cavity so as to allow, in use, a tow ball to engage into or disengage from the cavity, and an extended position in which the shoe extends into the cavity so as to obstruct the cross section of the cavity and, in use, prevent a tow ball from engaging into or disengaging from the cavity; wherein the tow cup further includes drive means operable to move the shoe between said engaged and disengaged positions and retain the shoe in each said position.

A tow cup in accordance with the invention has the advantage that, by providing drive means which actively moves the shoe between the engaged and disengaged positions, the operation of the tow cup is both simplified and made more reliable, and also facilitates monitoring of the proper engagement and disengagement of the shoe through monitoring of the position of the shoe either directly or indirectly through the drive means.

The shoe may be mounted in the passage so as to be constrained to slidably move between the engaged and disengaged positions, for example by engagement by a threaded actuator which pushes or pulls the shoe laterally towards or away from the cavity depending on the direction of rotation imparted to the threaded actuator by the drive means.

However, in the preferred embodiment of the invention the shoe is non-rotatably coupled to a drive shaft, whereby operation of the drive means to rotate the drive shaft causes rotation of the shoe and thereby causes it to either move towards or away from the cavity depending on the direction of rotation.

The drive actuator may be threaded so as to move laterally as it is rotated, moving the shoe with it. Preferably, however, the shoe has an outer surface on which a male thread is formed which engages with a complementary female thread formed on a mating inner surface of the passage, the drive shaft rotating the shoe, causing it to wind along the thread on the inner surface of the passage either towards or away from the cavity. In that case, the drive shaft slidably engages the shoe by way of a keyed interconnection so that the shoe is rotationally fast with but slidable along the drive shaft. In particular, the shoe has a bore extending at least partially therethrough in which the drive shaft engages, the cross section of the bore matching the cross section of the drive shaft, said cross sections effecting a rotationally fast interconnection between the drive actuator and the shoe. For example, the cross sections may be ovals, polygons, irregular matching shapes or any other shape which will effect a keyed and hence rotationally fast interconnection between the drive shaft and the shoe.

The drive shaft is preferably a close tolerance fit in the bore in the shoe so as to allow the shoe to slide on the drive shaft whilst minimising backlash in the drive of the shoe by the drive shaft. This has the advantage of maximising the responsiveness of the shoe to the drive means and hence accuracy of tracking the position of the shoe.

Preferably, friction means are provided on at least one of the outer surface of the shoe and the inner surface of the passage which increases the friction between the shoe and the passage so as to resist movement therebetween. This has the advantage of increasing the pre-torque on the shoe and hence helps to prevent unintentional unwinding of the shoe within the passage.

The friction means preferably comprises a circumferential seal such as an O-ring which is provided in a groove in one of the outer surface of the shoe and the inner surface of the passage.

The shoe preferably has a bore extending at least partially therethrough from a second end of the shoe, which is remote from the cavity, the drive shaft engaging in said bore, the cross section of the bore matching the cross section of the drive shaft so that the cross sections effects a rotationally fast but slidable interconnection between the drive shaft and the shoe. More particularly, the cross sections may be matching polygonal cross sections.

In the preferred embodiment, the drive means includes a drive train having a drive motor and at least one worm gear set, the drive motor being operable to rotate the shoe within the passage through said at least one worm gear set and the drive shaft. The meshing teeth of the at least one worm gear set have a low thread angle so that back driving of the motor through the or each worm gear set by rotation of the shoe is prevented. This has the advantage of providing a lock which prevents unintentional retraction of the shoe for example due to frictional engagement of the shoe by a tow ball engaged in the cavity of the tow cup as the towing vehicle rolls relative to the trailer.

The at least one worms gear set preferably includes worm teeth formed on the outer surface of a worm wheel and a mating worm gear provided on one end of a worm wheel drive shaft which is driven by the motor, the worm wheel being non-rotatably connected to the drive shaft for driving the shoe within the passage. The worm wheel preferably has a central bore in it, the drive shaft engaging in the central bore of the worm wheel so as to be rotationally fast therewith. The drive shaft is preferably slidably engaged in each of the shoe and the worm wheel.

The axial clearance between the shoe and the worm wheel is large enough such that the shoe can fully retract from the cavity without the drive shaft bottoming out in either the bore in the shoe or the bore in the worm wheel but is also sufficiently small that with the shoe fully extended the drive shaft always remains engaged in both shoe and worm wheel

A worm cog is preferably provided on one of a second end of the worm wheel drive shaft and a motor shaft of the drive motor which engages with a second worm gear carried on the other of the second end of the worm wheel drive shaft and the motor shaft of the drive motor.

Preferably, a first end of the shoe which in the extended position engages in the cavity has a concavely curved end face which complements the curvature of a tow ball which, in use, engages in the cavity.

### BRIEF DESCRIPTION OF THE DRAWINGS

In order that the invention may be well understood, there will now be described an embodiment thereof, given by way of example, reference being made to the accompanying drawings, in which:

FIG. 1 is a section through a part of a tow cup according to the invention with a tow ball engaged therein;

FIG. 2 is a section through the tow cup of FIG. 1

FIG. 3 is a perspective cut away view of the tow ball and tow cup of FIG. 1 with a body of the tow cup omitted;

FIG. 4 is a side view of the cut away assembly of FIG. 3;

FIG. 5 is a top view of the cut away assembly of FIG. 3;

FIG. 6 is a sectional view through a worm wheel which forms part of a drive train of the present invention; and

FIG. 7 is a section through the drive train of FIG. 6 including a drive motor.

### DETAILED DESCRIPTION OF THE PREFERRED EMBODIMENTS

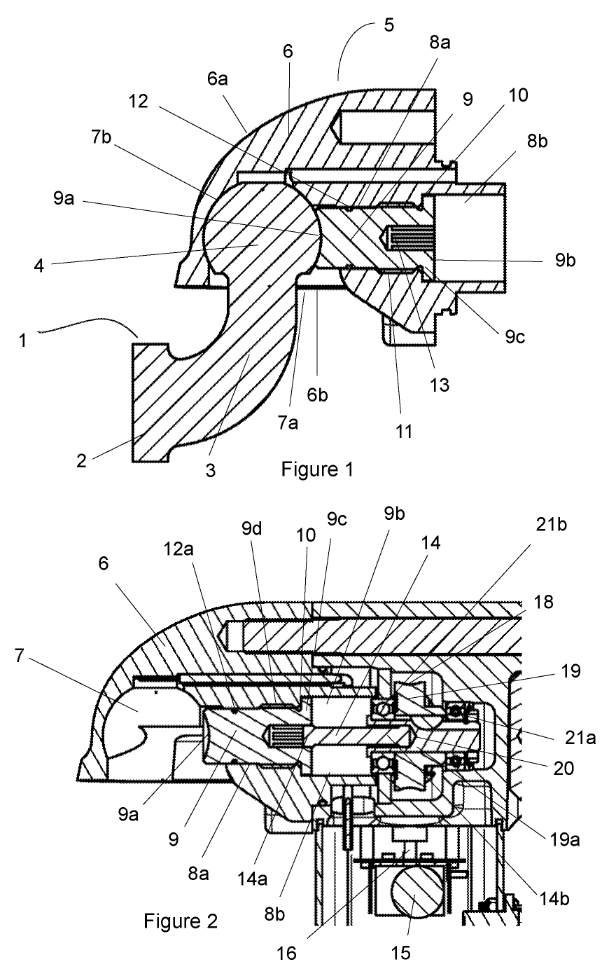

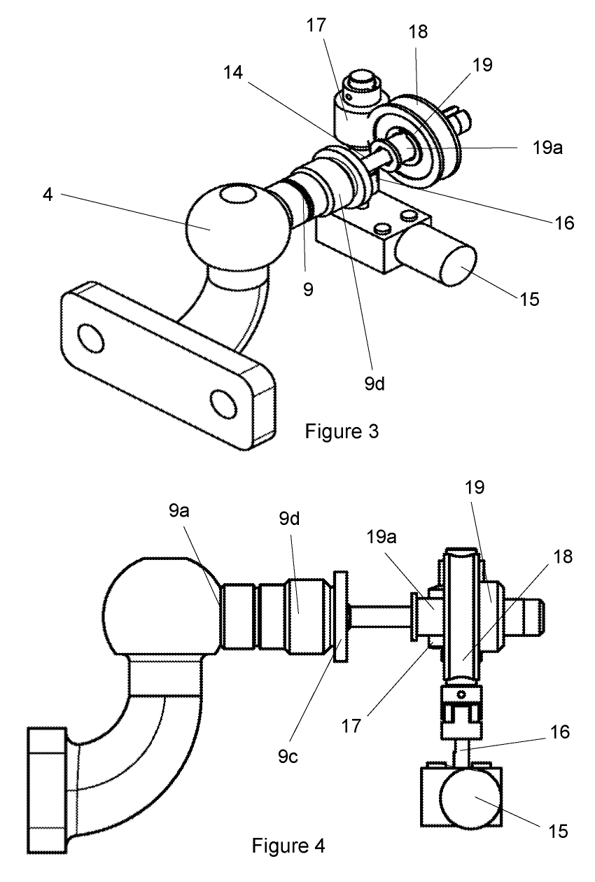

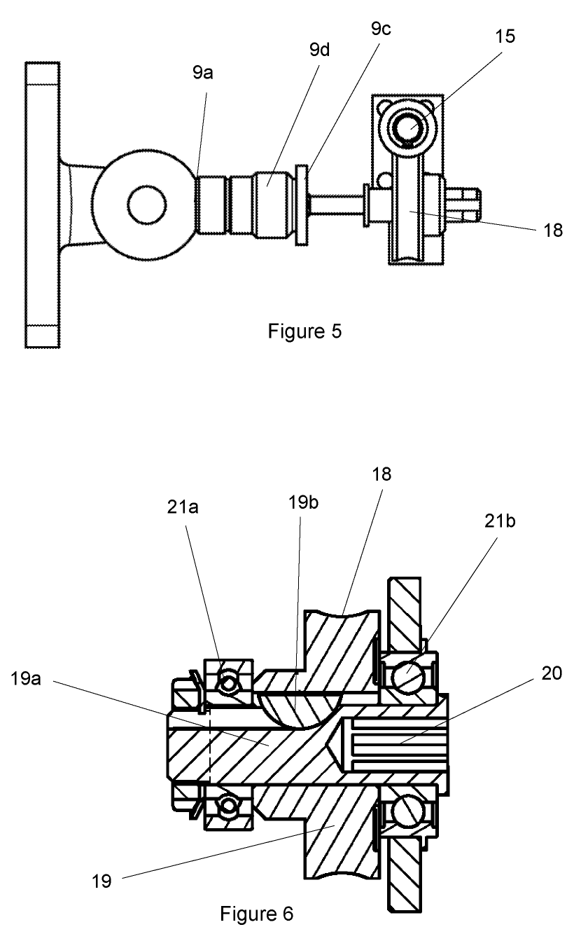

Referring first to FIG. 1, there is shown a towing assembly comprising a tow ball 1 and a tow cup 5 embodying the present invention. The tow ball 1 is of conventional construction with a base bracket 2 by means of which it can be secured to the back of a vehicle (not shown) which is to do the towing, a neck 3 extending from the base bracket 2, and a generally spherical ball 4 on the end of the neck 3 remote from the base bracket 2.

The tow cup 5 comprises a body 6 having a top 6a and a bottom 6b and a cavity 7 which is open 7a to the bottom 6b of the body 6 and extend upwards therefrom towards the top 6a, terminating in a generally hemispherical concave upper end 7b which is sized and shaped generally to complement the outer profile of the upper half of the spherical ball 4 of the tow ball 1. The open bottom end 7a of the cavity 7 is sized to allow the spherical ball 4 of the tow ball 1 to enter unimpeded so the spherical ball 4 can freely engage fully into the cavity 7 of the tow cup 5.

A passage 8 is formed in the body 6 which extends radially from the cavity 7 in alignment with the equator (largest circumference/latitude) of the spherical ball 4 when it is engaged in the cavity 7. As can be seen in FIGS. 1 and 2, the passage 8 is divided into a smaller cross section portion 8a which extends from the cavity 7 to a stepped transition 10 to a larger cross section portion 8b, the stepped transition 10 forming an abutment shoulder as described below. A female thread 11 is formed on the inner surface of the smaller cross section portion 8a of the passage 8 which extends along the passage 8 from the stepped transition 10 towards the cavity 8.

A shoe 9 is mounted in the passage 8 so as to be moveable longitudinally there along. The shoe 9 has a first end 9a which faces the cavity 8 and a second end 9b which is remote from the cavity and has a flange 9c formed thereon which cooperates with the abutment shoulder of the passage 8 to limit the movement of the shoe 9 along the passage in the direction of the cavity 8. A male thread 9d is formed on the outside of the shoe 9 which engages with the female thread 11 on the inner surface of the passage 8 so that rotation of the shoe within the passage causes it to move longitudinally along the passage either towards or way from the cavity 7 between an extended position (shown in FIG. 1) in which an first end 9a of the shoe 9 extends into the cavity 7 and the flange 9c engages against the shoulder, and a retracted position (FIG. 2) in which the shoe 9 is fully retracted into the passage 8.

As can be seen in FIGS. 1 and 2, the first end 9a of the shoe 9 is contoured so as to be spherically concave to match the curvature of the outer surface of the spherical ball 4 of the tow ball 1 so that when the shoe 9 is in its engaged position, the contoured first end 9a engages the side of the spherical ball 4 at its equator / widest latitude in a close tolerance manner, preventing it from being removed from the cavity whilst allowing it to pitch, roll and yaw – movement which will typically occur between a towing vehicle and a trailer as it travels along a road. On the other hand, in the retracted position, the contoured first end 9a is retracted away from the spherical ball 4, allowing it to be moved downwards relative to the tow cup 6 and out of the cavity 7. A groove 12 is formed in around the outside of the shoe 9 partway along in which is mounted an O ring seal 12a. The O ring seal 12a prevents ingress of moisture etc from the cavity through to the drive mechanism and importantly also increases friction between the shoe 9 and the passage 8, thereby increasing the torque preload on the shoe to inhibit unintentional movement of the shoe 9 within the passage 8.

The shoe 9 furthermore has a central bore 13 extending longitudinally from the second end 9b towards the first end 9a in which is non-rotatably engaged a first end 14a of a drive shaft 14 such the shoe 9 and the drive shaft 14 are constrained to rotate together. IN the illustrated embodiment, the central bore 13 has a hexagonal cross section and at least of portion of the drive shaft 14 has a corresponding hexagonal cross section which keys the two parts together rotationally but allows longitudinal movement therebetween to allow for movement of the shoe 9 along the passage 8, but it will be understood that other cross sections and keying mechanisms may be used.

In order to effect operational movement of the shoe 9 within the passage 8, a drive motor 15 is provided within the housing 6 of the tow cup 5. The drive motor 15 has an output shaft on which is mounted a first worm gear which engages with a mating first worm cog mounted on one end of an intermediate drive shaft 16 oriented at 90 degrees to both the output shaft of the drive motor 15 and the longitudinal axis of the shoe 9 and passage 8. The first worm gear and worm cog together form a first worm gear set. A second worm gear 17 is mounted on the other end 16a of the intermediate drive shaft 16 which drivingly engages with second worm teeth 18 formed around the outside of a worm wheel 19 which is positioned concentrically with the shoe 9 and passage 8. The second worm gear and worm cog 17, 18 form a second worm gear set.

The worm wheel 19 has a central bore 20 aligned with the central bore 13 of the shoe 9, in which a second end 14b of the drive shaft 14 engages in a rotationally fast manner such that the drive shaft 14 is constrained to rotate with the worm wheel 19 in a similar manner to the engagement between the drive shaft 14 and the shoe 9. In the illustrated embodiment, the central bore 20 of the worm wheel 19 also has a hexagonal cross section and at least a portion of the second end 14b of the drive shaft 14 has a corresponding hexagonal profile on its outer surface to effect a keyed connection between the worm wheel 19 and the drive shaft 14 whilst allowing longitudinal movement therebetween. The drive shaft 14 is long enough to ensure that it remains engaged with both the worm wheel 19 and the shoe 9 through the whole range of movement of the shoe 9.

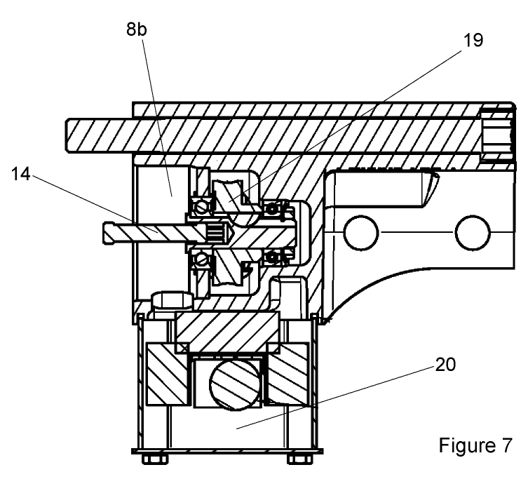

As shown in FIGS. 6 and 7, the worm wheel 19 is mounted on a worm wheel shaft 19a in which the central bore 20 is formed, the worm wheel 19 being keyed to the worm wheel shaft 19a by a woodruff key 19b, although it will be understood that other keying systems may be used. The worm wheel shaft is supported at each end by bearings 21a, 21b.

The drive motor 15 can be operated to rotate the output shaft in either direction. Upon rotation in a clockwise direction, the output shaft rotates the first worm gear which in turn rotates the engaged first worm cog in a counterclockwise direction, causing the intermediate drive shaft 16 and second worm gear 17 to rotate counterclockwise. The rotation of the second worm gear 17, in turn, drives the worm wheel 19 in a clockwise direction through its engagement with the second worm teeth 18, and the drive shaft 14 rotates clockwise with it, as does the shoe 9. The clockwise rotation of the shoe 9 causes it to screw along the thread 11 on the inner surface of the passage 8, moving it longitudinally along the passage 8 into its engaged position, the flange 9c of the shoe preventing it from moving too far along the passage 8.

Similarly, reversing the drive motor to rotate its output shaft in the counterclockwise direction results in reverse rotation of all the components of the drive train. Hence causing the shoe to rotate in the counterclockwise direction and hence moving it longitudinally away from the cavity 7 into its retracted position.

Sensors (not shown) and / or software controls are provided within the housing to allow the position of the shoe to be monitored to enable a control system for the drive motor to switch the motor off when the desired position of the shoe 9 within the passage 8 is reached. Such sensors and software controls are well known in the art and will not be described herein in more detail. The sensors can also be used to monitor if the shoe has been inadvertently moved from its desired position by external forces and the control system can react accordingly.

Each of the worm gears has a low thread angle so that they cannot be back driven – i.e. it is not possible to drive the drive motor through the drive train by screwing the shoe either clockwise or counterclockwise within the passage. They are therefore considered to provide static and dynamic locking. Accordingly, any torque applied to the face of the first end 9a of the shoe by the spherical ball 4 due to rolling motion between the towing vehicle and the trailer is prevented from causing rotation of the shoe 9 within the passage 8 in either direction, and hence prevents unintentional release of the spherical ball 4 from the cavity 7 of the tow cup 5.

The provision of two worm gear sets in series in the drive train between the motor enables the axis of rotation of the drive to be rotated through 90 degrees twice, allowing a more compact housing for the tow cup, with the drive motor in the illustrated embodiment being positioned below the drive shaft 14 and worm wheel 19.

What is claimed is:

1. A tow cup for a tow hitch assembly comprising a body having opposing upper and lower sides, and a cavity formed therein which is open to the lower side of the body and is sized and shaped to receive, in use, a complementary tow ball of the tow hitch assembly, the body further including a passage formed which extends from the cavity, and a shoe mounted in the passage so as to be moveable between a retracted position in which the shoe is retracted from the cavity so as to allow, in use, a tow ball to engage into or disengage from the cavity, and an extended position in which the shoe extends into the cavity so as to obstruct the cross section of the cavity and, in use, prevent a tow ball from engaging into or disengaging from the cavity; wherein the tow cup further includes drive means operable to move the shoe between said engaged and disengaged positions and retain the shoe in each said position, the shoe being non-rotatably coupled to a drive shaft, whereby operation of the drive means to rotate the drive shaft causes rotation of the shoe and thereby causes it to either move towards or away from the cavity depending on the direction of rotation, and the shoe having an outer surface on which a male thread is formed which engages with a complementary female thread formed on a mating inner surface of the passage, the drive shaft rotating the shoe, causing it to wind along the thread on the inner surface of the passage either towards or away from the cavity, wherein the drive means includes a drive train having a drive motor and at least one worm gear set, the drive motor being operable to rotate the shoe within the passage through said at least one worm gear set and the drive shaft.

2. The tow cup according to claim 1, wherein the drive shaft slidably engages the shoe by way of a keyed interconnection so that the shoe is rotationally fast with but slidable along the drive shaft.

3. The tow cup according to claim 1, wherein friction means are provided on at least one of the outer surface of the shoe and the inner surface of the passage which increases the friction between the shoe and the passage so as to resist movement therebetween.

4. The tow cup according to claim 3, wherein the friction means comprises a circumferential seal which is provided in one of the outer surface of the shoe and the inner surface of the passage.

5. The tow cup according to claim 2, wherein the shoe has a bore extending at least partially therethrough from a second end of the shoe which is remote from the cavity, the drive shaft engaging in said bore, the cross section of the bore matching the cross section of the drive shaft so that the cross sections effects a rotationally fast but slidable interconnection between the drive shaft and the shoe.

6. The tow cup according to claim 5, wherein said cross sections are matching polygonal cross sections.

7. The tow cup according to claim 1, wherein the at least one worm gear set includes a worm teeth formed on the outer surface of a worm wheel and a mating worm gear provided on one end of a worm wheel drive shaft which is driven by the motor, the worm wheel being non-rotatably connected to the drive shaft for driving the shoe within the passage.

8. The tow cup according to claim 7, wherein the worm wheel has a central bore in it, the drive shaft engaging in the central bore of the worm wheel so as to be rotationally fast therewith.

9. The tow cup according to claim 8, wherein the drive shaft is slidably engaged in each of the shoe and the worm wheel.

10. The tow cup according to claim 7, wherein a worm cog is provided on one of a second end of the worm wheel drive shaft and a motor shaft of the drive motor which engages with a second worm gear carried on the other of the second end of the worm wheel drive shaft and the motor shaft of the drive motor.

11. The tow cup according to claim 1, wherein the or each worm gear has a low thread pitch such that back driving of the drive train from the shoe to the motor is prevented.

12. The tow cup according to claim 1, wherein a first end of the shoe which in the extended position engages in the cavity has a concavely curved end face which complements the curvature of a tow ball which, in use, engages in the cavity.
